(19) United States
(12) Patent Application Publication
(10) Pub. No.: US 2024/0189688 A1
(43) Pub. Date: Jun. 13, 2024

(54) SPARRING GARMENT AND WEAPON SYSTEM

(71) Applicants: Peter Scott Shirley, League City, TX (US); Stefanie Kaye Silvano Shirley, Houston, TX (US)

(72) Inventors: Peter Scott Shirley, League City, TX (US); Stefanie Kaye Silvano Shirley, Houston, TX (US)

(21) Appl. No.: 18/063,325

(22) Filed: Dec. 8, 2022

(51) Int. Cl. A63B 69/32; A41D 1/00; A63B 69/00; G01L 1/18; G01L 5/00

(52) U.S. Cl. CPC A63B 69/32; A41D 1/002; A63B 69/333; G01L 1/18; G01L 5/0052; A63B 2220/53; A63B 2225/50; A63B 2225/74

(57) ABSTRACT

A combat system is disclosed that includes a garment and a weapon. The garment includes a computing device and a plurality of sensors positioned across the garment. The sensors are operable to detect an impact thereto from the weapon. The impact is measured in terms of pressure and duration and used to calculate a resultant damage amount.

### BACKGROUND OF THE INVENTION

The present invention relates to training weapon systems and, more particularly, to a system that includes a computer-controlled sparring vest and intelligent training weapons for use in a variety of scenarios, such as martial arts training and live-action role-playing.

When sparring with training weapons, it is often difficult to simulate damage or disarms and to determine winners/losers based on damage taken. It is also difficult to differentiate between areas of simulated critical damage and areas of simulated minor damage.

Existing systems are deficient for many reasons. For example, they require multiple devices (e.g., a weapon, wiring, and a readout panel). These devices are non-wearable, require blunt force impact, have no real-time wireless communications between devices, and have no measurement of the strike force, or simulated damage based on weapon. Furthermore, electrical connections requiring a tether restrict movement, can be dangerous if caught, and are prone to failure. Blunt force impact equipment requires hard hits with weapon to register, potentially causing injury. Moreover, sensors cannot differentiate between different simulated weapons for damage calculations.

As can be seen, there is a need for a sparring/combat system as described herein.

### SUMMARY OF THE INVENTION

In one aspect of the present invention, a combat system is disclosed that comprises: a garment further comprising a computing device and a plurality of garment sensors positioned across the garment and operable to detect an impact thereto, the impact comprising a pressure and a duration that is used to calculate a resultant damage amount.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a schematic view of an embodiment of the present invention;

FIG. 2 is a schematic view of a wearable apparatus wiring of the embodiment of the present invention;

FIG. 3 is a schematic view of a wearable apparatus of the embodiment of the present invention;

FIG. 4 is a schematic view of wearable apparatus sensor pad layers of the embodiment of the present invention;

FIG. 5 is a schematic view of a weapon of the embodiment of the present invention; and

FIG. 6 is a flow chart depicting a process of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

The present invention uses impact force, duration, time, and location to determine whether a respective user struck prior to another user and assigns the strike a level of simulated damage based on location and weapon type. It keeps track of damage over the course of time and declares a winner in sparring matches and play fighting. The present invention also pairs strike timing with strike location and weapon type to simulate critical damage for various purposes, such as for training.

The present invention is completely self-contained, wearable/holdable, and is lightweight. The vest may include integrated area sensors that monitor for hits and are compatible with any training weapons. The present invention also utilizes bi-directional wireless communication (e.g., radio communication) between a plurality of sensors (e.g., the intelligent weapon and vest pads) to simulate increased damage for particular types of training weapons. Prior to the present invention, there were no systems that measured damage, displayed remaining hit points, or had “smart” weapons that communicated between the damage-receiving and damage-inflicting devices. Prior to this present invention there were no systems that allowed for the identification that critical blow has been hit by a certain weapon in a certain area (i.e., knife strike to an artery is fatal versus stick strike to the same location is non-fatal).

Advantageously, the present invention is a stand-alone, wearable, battery-powered, and includes multiple sensors that measure pressure with adjustable sensitivity to register hits without causing physical damage to the wearer. Compatible with any training weapon, but also can be paired with “smart” weapons for enhanced simulations. The present invention measures total damage and area damage to indicate when a specific area has reached maximum damage.

The smart weapons may be designed with modular inserts that can be pre-programmed and inserted into the weapon. The programmable aspect of the inserts allow for the weapon to identify it's type for damage calculations. This will allow a user to have multiple weapon housings (i.e., sword, knife, axe) and a single programmable insert that can be switched between the weapon housings.

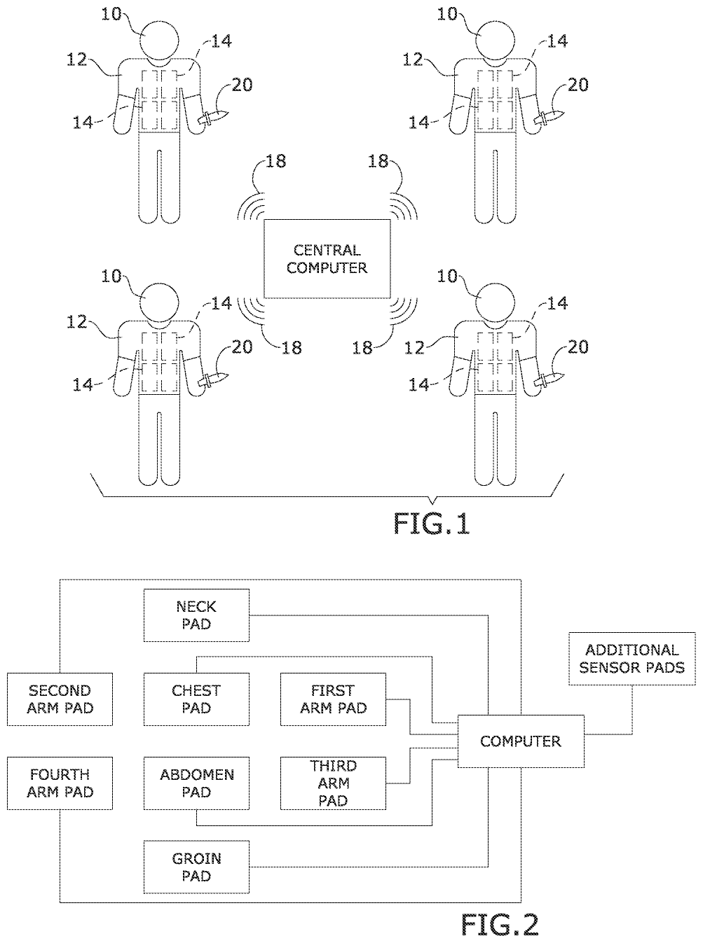

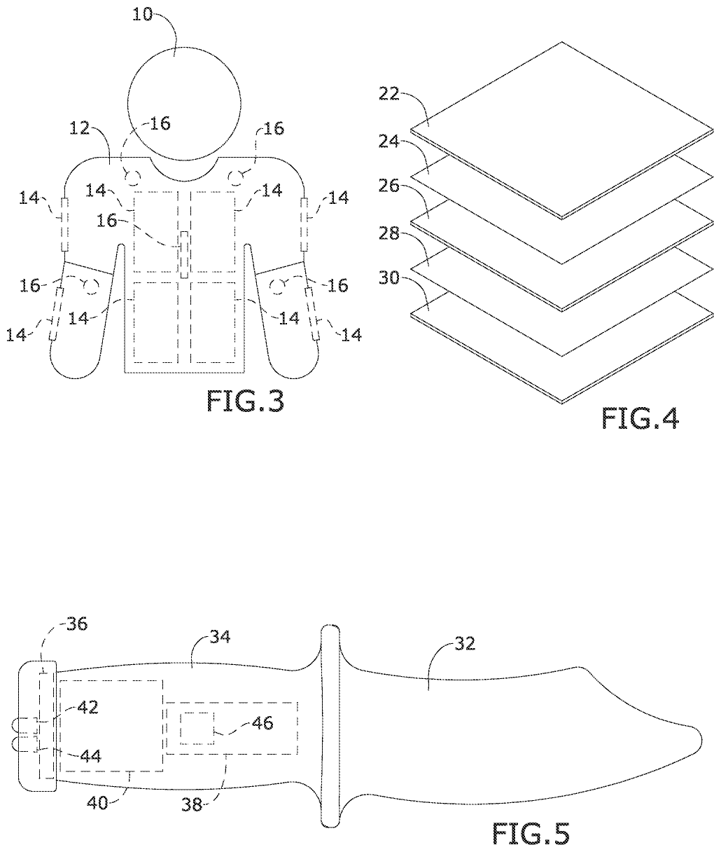

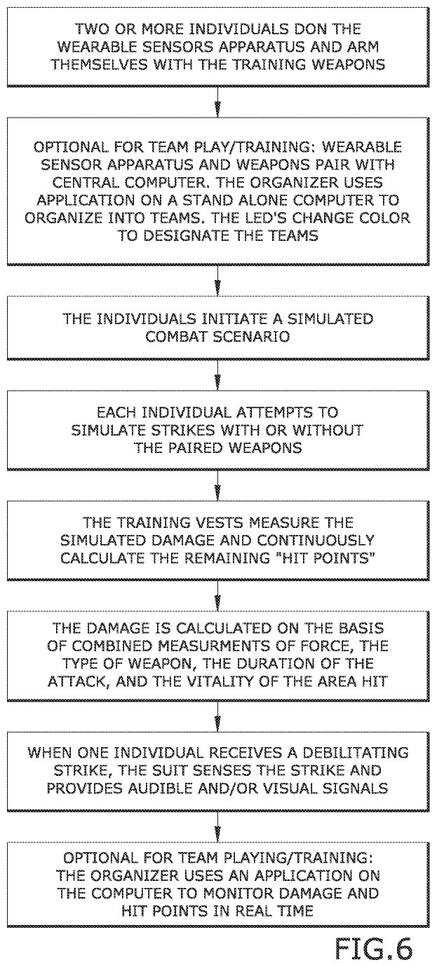

Referring now to FIGS. 1 and 3, a system and method of use of the present invention includes a plurality of users 10 that each don a wearable sensor garment 12 (e.g., a vest) and hold a weapon 20. Each garment 12 includes a plurality of sensor pads 14. As shown in FIG. 3, the garment additionally may include a plurality of lights 16, which may be, for example, light emitting diodes (LEDs). The garments 12 and weapons 20 of the respective users intercommunicate via a wireless signal 18. In certain embodiments, this may be achieved through radio or other short-range wireless communication technology. In other embodiments, it may be implemented via a central computer system, e.g., a cloud computing system.

In particular embodiments, a communication interface on the garments 12 includes hardware, software, or both providing one or more interfaces for communication (such as, for example, packet-based communication) between a computer system (as shown in FIG. 2) and one or more other computer systems on nearby garments 12 or one or more networks. As an example, communication interface may be a wireless network interface controller (WNIC) or wireless adapter for communicating with a wireless network, such as a WI-FI network. This disclosure contemplates any suitable network and any suitable communication interface 810 for it. As an example, computer system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer system may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The computer system may include any suitable communication interface for any of these networks, where appropriate. Communication interface may include one or more communication interfaces, where appropriate. Although this disclosure describes and illustrates a particular communication interface, this disclosure contemplates any suitable communication interface.

Making reference to FIG. 2, a schematic arrangement of sensor pads 14 is shown. The sensor pads 14 may be positioned in common locations where strikes commonly occur. For example, arm portions of the garment 12 may include a plurality of arm pad sensors, a neck pad sensor, a chest pad sensor, an abdomen pad sensor, and a groin pad sensor. Other sensor locations may be employed in accordance with the present invention. These sensor pads 14 are electrically coupled to a computing device on the garment 12, with the computing device processing data transmitted by the sensors 14 regarding strikes thereto (e.g., the location of the strike and the impact force).

As depicted in FIG. 4, the sensor pads 14 may employ the following exemplary configuration. As a top layer, each pad 14 may have a first non-conductive layer 22, a signal-in conductive layer 24, a resistive pad 26, a grounded conductive layer 28, and a second non-conductive layer 30 sequentially stacked and operably coupled to form the pad 14. In certain embodiments, the non-conductive insulating layers 22, 30 may be omitted. As presently embodied, the sensor pads 14 are pressure sensitive (they are electrically conductive and change resistance when compressed). In certain embodiments, the sensor pads 14 may include a piezo resistive sensor that is structural in nature. Other piezo-resistive fabric-type materials pre-compress and are not useful in the present application.

In certain embodiments, the garment computing device (which may include, for example, a processor configured to process and execute instructions, and non-transitory computer readable media) may be attached to a board that contains I/O ports, and resistors for voltage bridges. The sensor pads 14 may be wired up in parallel, completing the voltage bridges. When compressed, resistance changes in the pads 14, in turn, change voltage on the 1/O ports. That voltage change may be measured by the garment computing device. Voltage read by resistance bridge comprised of wearable resistance pads 14 is monitored. If voltage changes beyond a programmable sensitivity threshold, it registers a “hit event”. The computing device may then send signals to the lights 16 to turn off, on, and/or change color of LED lights to simulate damage. The sensed voltage drop is used to calculate damage received by each area. The computer may be programmable to calculate simulated damage mechanisms based on pre-determined and adjustable values and algorithms. The computer calculates the damage in each area (e.g., hand, neck, stomach, etc.) to determine if LED lights 16 should turn on and to which color (e.g., red/green/yellow). Based on the nature of the strike (force, timing, location), the computer also calculates total hit points taken to determine if an individual has lost, disarmed or has sustained critical damage to a certain location. Based on percentage of total calculated damage taken, the computer can determine the number of LED lights to light up in a strip of LEDs 16 and which color (red/green/yellow) based on total damage. If total damage available is exceeded, the computer may turn all the lights 16 red, signifying a loss. The computer may then wait a pre-determined amount of time, then reset all variables to start over.

Turning now to FIG. 5, the weapon 20 may be configured as depicted in that figure, although other arrangements may be employed without departing from the spirit and scope of the present disclosure. Externally, the weapon 20 may include a contact end 32 and a handle 34. In FIG. 5, the contact end 32 is depicted as a flexible blade, but other forms of weapon 20 may be appropriate, depending upon use. Internally, the weapon 20 may include a conducting pad 36, a weapon computing device 38, a power source 40 (e.g., a battery), a first LED 42 and a second LED 44 partially protruding from the butt of the handle 34, and an auditory device 46. The weapons 20 are also configured to wirelessly communicate with the garments 20 and/or the central computer system to signal when it successfully struck something (measured with the electrically conductive compressible material 36 and a voltage bridge similar to the garments 12). This signal/report from the weapon 20 pairs with the signal/report from the garment 12 to determine where a hit took place and how much damage is to be assessed. This works in a 1 versus 1 scenario, as well as in scenarios where a large number of players are involved (e.g., a live action role-playing scenario). In both, the system independently determines what player was hit, and by whom, using data collected by the garments 12 and weapons 20.

In use, the computing devices on the respective garments 12 and weapons 20 communicate with one another and/or a central computer to determine a winner. The garments 12 sense impacts thereto and provide visual clues when sparring with the weapons 20 to determine a winner in a training match or in other uses (e.g., in a role-playing use). When worn during sparring/training, the present invention provides visual clues that contact (simulated damage) has occurred via the LEDs 16.

The system (via, for example, the central computer) is also operable to adjust displays/LED lights 16 based on the team assignments, amount of damage and ultimately determine when a maximum amount of damage has taken place. The central computer can modify the LED lights 16 displayed on the user's garment 12. For example, it can change colors of the LED lights 16 on the garment 12 to identify teams (e.g. “blue team” vs. “purple team”) and damage taken (e.g., green/yellow/red). The system may also include companion devices (i.e., smart phone or other external displays/computing devices) which can be used to assign teams, colors, monitor simulated combat, other computer simulations, and provide other metrics.

More specifically, two or more individuals would don the training garments 12 and arm themselves with training weapons 20. They would initiate a simulated combat scenario (e.g., for self-defense purposes). They would simulate strikes against one another with (or without) the paired weapons. Each user's garment 12 measures simulated damage and keeps track of remaining “hit points”. If one combatant receives a debilitating blow, the garment 12 senses this (as described above) and provide audible/visual clues. For example, if a user had a weapon 20 in their right hand, it would disable that weapon 20 and the LED 16 on the user's right arm would turn red to indicate that they are disarmed.

As has been mentioned above and would be readily apparent to those with skill in the art, the present invention has many potential uses. For example, it can be used as a tool for improving self-defense and protect against debilitating weapon strikes. It could be used as a children's toy to play swords (e.g., it could be sold as a kit at a toy store). It could also be used for live-action role-playing and simulation of magic effects. Multiple players could congregate and use nearfield detection effects (or similar) to quickly join teams and start a battle. Once a person receives critical damage, his/her weapons and would deactivate and he/she must leave the simulated combat area. The simulated group combat may be monitored by a central computing device (e.g., laptop or smartphone) which facilitates the assignment of team members, sends signals to LEDs 16 to identify teams, pairs weapons with vests, reports combat metrics and monitors team performance.

A method of making an exemplary embodiment of the present invention may be as follows. It will be appreciated by those with skill in the art that other may techniques may be employed, such that the above functionality is enabled. The sensing pads are made using electrically conductive 3d printer filament to print flexible shapes (typically square rectangular, but could be molded to other shapes/contours) of a desired dimension (e.g., 8″×8″×¼ ″). Other fabrication techniques may be more efficient (e.g., injection molding, etc.). These form the critical components of the resistive bridge for the sensing pads. These pads may be sandwiched within two sheets of conductive material (e.g., copper fabric) which complete the circuit. This, in turn, may be sandwiched between two insulating sheets of flexible insulating (e.g., TPU) material. Multiple sensors may be assembled to form a network of multiple sensing pads with a common ground circuit and individual sensing lines. The fabricated electrically conductive pads may be made from TPU 95A (or similar) electrically conductive material (or similar) which changes resistance when compressed. The insulating sandwich components may be made from non-electrically conductive TPU (rubberized) material (or similar).

The micro-computers employed may have BLUETOOTH™ or other short-range wireless communications capability for communications between computing devices.

Each pad's sensing line may be connected to the micro-computer to form a voltage bridge. The change in voltage upon compression may be sensed by the microcomputer which, in turn, determines follow-on actions (as described above).

The sensing pads may be housed in a wearable vest which also is equipped with wearable LED lights. The LED lights may be wired to the micro-computer's digital output in series to provide visual signals corresponding to calculated outcomes.

The paired weapons (e.g., knives) may be three-dimensional printed and are fabricated using thermoplastic polyurethane (TPU) (flexible/rubberized) material (or similar). They may contain internal slots for housing sensors (e.g., one along the blade to measure blade flex/bend, and in the handle another to measure compression force). These may be electrically connected to a transmitter in the handle which communicates to the garment computer via BLUETOOTH™.

Further, potential modifications and improvements may include the following. Additional paired weapon sizes and types could be employed, with more elaborate LED displays to show impact at specific locations (e.g., actual location of hit vs. representative location). Networking among multiple devices may be employed (as mentioned above), as well as a companion systemic software application developed (e.g., for a smart phone) which can be used to calibrate, pair multiple suits, set up multi-combatant sparring events, etc.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

1. A combat system comprising:
a first combat garment further comprising:
a computing device; and
a plurality of garment sensors positioned across the first combat garment and operable to detect an impact thereto, the impact comprising a pressure and a duration that is used to calculate a resultant damage amount; and
a weapon wirelessly communicative with the computing device for sending a weapon report thereto upon the weapon physically striking first combat garment, wherein the weapon report defines a weapon type of the associated weapon, wherein the resultant damage amount is based on, in part, the weapon type.

2. The combat system of claim 1, wherein the computing device calculates the resultant damage amount.

3. The combat system of claim 1, wherein the weapon comprises one or more weapon sensors that are electrically conductive and change resistance when compressed.

4. The combat system of claim 1, wherein each of the plurality of garment sensors are electrically conductive and change resistance when compressed to detect the pressure and the duration of the impact.

5. The combat system of claim 1, wherein each of the plurality of garment sensors are piezoresistive sensors and provide protective padding to the first combat garment.

6. The combat system of claim 1, wherein the plurality of garment sensors comprises one or more arm pad sensors, neck pad sensors, chest pad sensors, abdomen pad sensors, groin pad sensors and head sensors.

7. The combat system of claim 1, further comprising a central computer that the computing device is configured to communicate with.

8. The combat system of claim 1, further comprising a second combat garment further comprising a second computing device and a plurality of second garment sensors.

9. The combat system of claim 8, wherein the first combat garment and the second combat garment are configured to pair and communicate with one another.

10. The combat system of claim 1, wherein the first combat garment further comprises a plurality of light-emitting diodes, the plurality of light-emitting diodes being configured to change appearance based upon the resultant damage amount calculated.

11. The combat system of claim 10, wherein each light-emitting diode of the plurality of light-emitting diodes is associated with a respective garment sensor of the plurality of garment sensors.

12. A combat system comprising:
a plurality of combat garments paired and in communication with one another, each combat garment further comprising:
a computing device; and
a plurality of garment sensors positioned across the respective combat garments and operable to detect an impact thereto, the impact comprising a pressure and a duration that is used to calculate a resultant damage amount; and
a weapon associated with each combat garment, each weapon being configured to wirelessly communicate with the computing device for sending a weapon report thereto upon the weapon physically striking first combat garment, wherein the weapon report defines a weapon type of the associated weapon, wherein the resultant damage amount is based on, in part, the weapon type.

13-15. (canceled)

16. The combat system of claim 12, wherein each weapon is paired with the plurality of combat garments to communicate when a respective weapon impacts a respective garment sensor.

17. The combat system of claim 12, wherein the plurality of combat garments comprises a first combat garment, a second combat garment, a third combat garment, and a fourth combat garment.

18. The combat system of claim 17, further comprising a central computer that is configured to assign the first combat garment and the second combat garment to a first team and the third combat garment and the fourth combat garment to a second team.

19. The combat system of claim 18, wherein each combat garment comprises light-emitting diodes that communicate team assignments.

20. The combat system of claim 18, further comprising any plurality of combat garments assigned to any plurality of teams.

21. The combat system of claim 1, further comprising a removable weapon insert configured to operatively associate with the weapon so as to define the weapon type of the associated weapon.

22. The combat system of claim 12, further comprising a removable weapon insert configured to operatively associate with each weapon so as to define the weapon type of the associated weapon.

23. The combat system of claim 12, wherein each combat garment is configured to determine that the resultant damage amount is equal to or greater than a critical damage amount, and wherein the associated weapon is configured to deactivate upon a critical damage amount determination.
